(19) United States
(12) Patent Application Publication
(10) Pub. No.: US 2025/0320395 A1
(43) Pub. Date: Oct. 16, 2025

(54) CRYOGENIC INORGANIC PHASE CHANGE MATERIAL AND PREPARATION METHOD AND APPLICATION THEREOF

(71) Applicant: Shanghai Shengsheng Logistics Co., LTD., Shanghai (CN)

(72) Inventors: YUCHEN ZHANG, Shanghai (CN); YUNLONG GUO, Shanghai (CN); YONGHONG PENG, Dalian (CN)

(21) Appl. No.: 18/672,127

(22) Filed: May 23, 2024

(30) Foreign Application Priority Data
Apr. 16, 2024 (CN) 202410452964.3

(51) Int. Cl. C09K 5/06

(52) U.S. Cl. CPC C09K 5/066

(57) ABSTRACT

A cryogenic inorganic phase change material, a preparation method and an application thereof are provided. The cryogenic inorganic phase change material includes parts by mass of raw materials in the following: 35-45 parts of a main material, 2-5 parts of a temperature regulating material, 0.5-2 parts of an inorganic nucleating agent and 55-60 parts of a solvent; the main material is lithium bromide; the temperature regulating material is one or more of ammonium chloride, magnesium chloride, calcium chloride, or sodium bromide, a phase transition temperature is −72˜−70° C., with high latent heat of phase transition, it is an efficient substitute for dry ice in cold chain delivery. The formula components are all inorganic, non-toxic and harmless, with low subcooling degree and good cycling stability. It can effectively match a transportation temperature range of bioactive drugs and avoid an impact of carbon dioxide on bioactive drugs.

### CROSS-REFERENCE TO RELATED APPLICATIONS

This application claims priority to Chinese Patent Application No. 202410452964.3, filed on Apr. 16, 2024, which is hereby incorporated by reference in its entirety.

### TECHNICAL FIELD

The present disclosure relates to the field of cold storage materials technologies, and in particular, to a cryogenic inorganic phase change material, and also relates to a preparation method and an application of the cryogenic inorganic phase change material.

### BACKGROUND

Phase change material is a type of material that absorbs or releases a large amount of heat during phase change. It usually uses its melting and solidification process to complete the absorption and release of heat, thereby maintaining a relatively stable ambient temperature. It is an ideal thermal management material and widely used for temperature control in specific situations. Due to the latent heat of phase change materials, it possesses a high energy storage density and keeps stable temperature during its phase change process. The phase change material has been widely used in industries such as energy storage, food, medicine, and chemicals due to an increasing awareness of global energy conservation and a demand for heat management in many industries.

In recent years, with the advancement of medical technology, some new bioactive drugs have emerged, which are difficult to develop and require strict storage conditions. They usually need to be stored and transported at temperature below −65° C. Typically, dry ice is used as the refrigerant to obtain an ultra-low temperature range of −90° C. to −60° C. However, with the continuous emergence of new bioactive drugs, some drugs are found sensitive to carbon dioxide, exposure to carbon dioxide of high concentration for a long time may cause decrease or even loss of drug efficacy. In this situation, it is not possible to use dry ice as the refrigerant for temperature control, which causes great inconvenience to the transportation process. Developing phase change materials suitable for this temperature range without dry ice has great practical value.

At present, there is relatively little research on phase change material in the temperature range of −75˜−65° C. For example, in patent of CN116515460A, lithium chloride is used as a main temperature regulating material, and the phase change temperature of a prepared phase change material is −65˜−63° C., which is relatively high. The system has poor uniformity and stability during application, and there is a significant risk of failure; in patent of US2023/0265331 A1, lithium bromide is used as the main temperature regulating material. The phase change temperature of the prepared phase change material is about −68˜−66° C., which is relatively high. Besides, subcooling degree during a freezing process is about 7-12° C., which results in harsh cold storage treatment condition and high difficulty in use during the application process.

### SUMMARY

A purpose of the present disclosure is to provide a cryogenic inorganic phase change material, which has a phase change temperature of −72˜−70° C., high latent heat of phase change, and can be used as an efficient substitute for dry ice in cold chain delivery. The formula components are all inorganic, non-toxic and harmless, with low subcooling degree and good cycling stability. It can effectively match a transportation temperature range of bioactive drugs and avoid an impact of carbon dioxide generated in a conventional temperature control transportation with dry ice on bioactive drugs. In addition, the present disclosure further provides a preparation method for the cryogenic inorganic phase change material and an application thereof in an ultra-low temperature control scenario.

In order to achieve the above objectives, the present disclosure adopts the following technical solutions.

A first aspect of the present disclosure provides a cryogenic inorganic phase change material, including parts by mass of raw materials in the following:
35-45 parts of a main material, 2-5 parts of a temperature regulating material, 0.5-2 parts of an inorganic nucleating agent, and 55-60 parts of a solvent;
where the main material is lithium bromide;
the temperature regulating material is one or more of ammonium chloride, magnesium chloride, calcium chloride, or sodium bromide.

In an embodiment of the present disclosure, the cryogenic inorganic phase change material includes parts by mass of raw materials in the following:
35-40 parts of the main material, 2-4 parts of the temperature regulating material, 1-2 parts of the inorganic nucleating agent, and 56-60 parts of the solvent.

In an embodiment of the present disclosure, the cryogenic inorganic phase change material includes parts by mass of raw materials in the following:
38 parts of the main material, 2 parts of the temperature regulating material, 1 part of the inorganic nucleating agent, and 59 parts of the solvent; or
36 parts of the main material, 4 parts of the temperature regulating material, 1 part of the inorganic nucleating agent, and 59 parts of the solvent.

In an embodiment of the present disclosure, the temperature regulating material is a mixture of ammonium chloride and sodium bromide.

In an embodiment of the present disclosure, a mass ratio of the ammonium chloride to the sodium bromide is 1:1.

In an embodiment of the present disclosure, the inorganic nucleating agent is at least one of sodium tetraborate and nano-silica.

In an embodiment of the present disclosure, the inorganic nucleating agent is a mixture of the sodium tetraborate and the nano-silica, and a mass ratio of the sodium tetraborate to the nano-silica is 1:1.

In an embodiment of the present disclosure, the solvent is deionized water.

A second aspect of the present disclosure provides a preparation method for the cryogenic inorganic phase change material, including the following steps:
S1: weighing the main material, temperature regulating material, inorganic nucleating agent, and solvent according to a formula amount;
S2: stirring and mixing the main material, temperature regulating material, and solvent evenly;
S3: adding the inorganic nucleating agent, continuing to stir and dispersing evenly to obtain the cryogenic inorganic phase change material.

A third aspect of the present disclosure provides an application of the cryogenic inorganic phase change material, the cryogenic inorganic phase change material is configured to be applied in an ultra-low temperature control scenario, and an ultra-low temperature control range is −72 to −70° C.

Compared with existing technology, the present disclosure has the following beneficial effects:
(1) the main material, temperature regulating material, and nucleating agent used in the present disclosure are all inorganic substances, and the solvent used is deionized water. The raw materials used are easy to obtain, safe, environmentally friendly, and the preparation process is simple;
(2) the cryogenic inorganic phase change material prepared according to a formula amount of the present disclosure has a phase change temperature of −72˜−70° C., which matches well with an active temperature range of biological drugs and greatly reduces a risk of failure caused by high temperature;
(3) the use of this cryogenic inorganic phase change material does not produce carbon dioxide, thereby completely avoiding a potential failure of bioactive drugs due to carbon dioxide toxicity in a transportation scenario with dry ice;
(4) this cryogenic inorganic phase change material has low subcooling degree and good cycling stability, thereby greatly reducing a difficulty of cold storage treatment during use;
(5) this cryogenic inorganic phase change material in the present disclosure is an aqueous solution with no phase separation risk, can maintain good cycling performance without adding thickeners. It can be reused multiple times, has low comprehensive cost, and is environmentally friendly.

### BRIEF DESCRIPTION OF DRAWINGS

Below, a further detailed explanation of the present disclosure will be provided in combination with the accompanying drawings and specific embodiments.

FIG. 1 shows a DSC curve of a cryogenic inorganic phase change material prepared in Example 1 of the present disclosure.

FIG. 2 shows the DSC curve of an inorganic phase change material prepared in Comparative Example 1 of the present disclosure.

FIG. 3 shows a cooling/melting curve of the cryogenic inorganic phase change material prepared in Example 1 of the present disclosure.

FIG. 4 shows the cooling/melting curve of the inorganic phase change material prepared in Comparative Example 1 of the present disclosure.

FIG. 5 shows a temperature change curve of an insulated container test of the cryogenic inorganic phase change material prepared in Example 1 of the present disclosure.

### DESCRIPTION OF EMBODIMENTS

For a convenience of understanding the present disclosure, the following will provide a more comprehensive and detailed description of the present disclosure in combination with preferred embodiments. However, the protection scope of the present disclosure is not limited to the following specific embodiments.

Unless otherwise defined, all professional terms used in the following have the same meanings as those commonly understood by those skilled in the art. The professional terms used in the present specification are only for a purpose of describing a specific embodiment and are not intended to limit the protection scope of the present disclosure.

A first aspect of the present disclosure provides a cryogenic inorganic phase change material, including parts by mass of raw materials in the following:
35-45 parts of a main material, 2-5 parts of a temperature regulating material, 0.5-2 parts of an inorganic nucleating agent, and 55-60 parts of a solvent;
where the main material is lithium bromide;
the temperature regulating material is one or more of ammonium chloride, magnesium chloride, calcium chloride, or sodium bromide.

A phase change temperature of the cryogenic inorganic phase change material in the present disclosure is −72˜−70° C., with high latent heat of phase change. It can be used as an efficient substitute for dry ice in cold chain delivery. Its formula components are all inorganic, non-toxic and harmless, with low subcooling degree, no phase separation risk, good cycling stability, and can effectively match a transportation temperature range of bioactive drugs, thereby avoiding an impact of carbon dioxide generated in a conventional temperature control transportation with dry ice on bioactive drugs.

Where, the main material can be, but are not limited to, 35, 36, 38, 40, 42 or 45 parts by mass; the temperature regulating material can be, but are not limited to, 2, 3, 4, or 5 parts by mass; the inorganic nucleating agent can be 0.5, 1, or 2 parts by mass, the solvent can be, but is not limited to, 55, 56, 58, or 60 parts by mass.

In order to achieve a better performance, the component amount of the cryogenic inorganic phase change material was optimized to obtain raw materials according to the following parts by mass:
35-40 parts of the main material, 2-4 parts of the temperature regulating material, 1-2 parts of the inorganic nucleating agent, and 56-60 parts of the solvent.

In an implementation, the parts by mass of raw materials are:
38 parts of the main material, 2 parts of the temperature regulating material, 1 part of the inorganic nucleating agent, and 59 parts of the solvent; or,
36 parts of the main material, 4 parts of the temperature regulating material, 1 part of the inorganic nucleating agent, and 59 parts of the solvent.

In some implementations, the temperature regulating material is a mixture of ammonium chloride and sodium bromide, which can more accurately adjust a required phase transition temperature and narrow the temperature range during a melting process.

In an implementation, when the temperature regulating material is a combination of ammonium chloride and sodium bromide, a mass ratio of the ammonium chloride and the sodium bromide is 1:1.

The inorganic nucleating agent is typically but not limited to at least one of sodium tetraborate and nano-silica.

In some implementations, the inorganic nucleating agent is a mixture of sodium tetraborate and nano-silica, which can effectively reduce subcooling degree of the phase change material and reduce a difficulty of cold storage treatment during use.

In an implementation, when the inorganic nucleating agent is a combination of the sodium tetraborate and nano-silica, the mass ratio of the sodium tetraborate to the nano-silica is 1:1.

The solvent is typically but not limited to deionized water.

A second aspect of the present disclosure provides a preparation method for the cryogenic inorganic phase change material, and the preparation method includes the following steps:
S1: weighing the main material, temperature regulating material, inorganic nucleating agent, and solvent according to a formula amount;
S2: stirring and mixing the main material, temperature regulating material, and solvent evenly;
S3: adding the inorganic nucleating agent, continuing to stir and dispersing evenly to obtain the cryogenic inorganic phase change material.

It can be understood that a range of normal temperature is 18 to 25° C.

In some implementations, the dispersing can be achieved through high-speed stirring, for example, stirring at a speed of 1200-1600 rpm for 10-15 minutes.

A third aspect of the present disclosure provides an application of the cryogenic inorganic phase change material, the cryogenic inorganic phase change material is configured to be applied in an ultra-low temperature control scenario, and an ultra-low temperature control range is −72 to −70° C.

The present disclosure will be further explained through embodiments below. Unless otherwise specified, the various reagents and raw materials used in the present disclosure are products that can be purchased from the market or made through well-known methods.

The lithium bromide, ammonium chloride, magnesium chloride, calcium chloride, sodium bromide, and sodium tetraborate used in the embodiments of the present disclosure are all directly purchased from the market;

the nano-silica is a commercially available hydrophilic gas-phase silica with a specific surface area of 200 m²/g.

### Example 1

This example provides a cryogenic inorganic phase change material, calculated in 100 parts by mass, including the following parts by mass of raw materials:

36 parts of the main material (lithium bromide), 4 parts of the temperature regulating material (2 parts of ammonium chloride and 2 parts of sodium bromide), 1 part of the inorganic nucleating agent (0.5 parts of sodium tetraborate and 0.5 parts of nano-silica), and a remaining amount of deionized water.

The preparation method of the cryogenic inorganic phase change materials:
the main material and temperature regulating material according to the parts by mass were added to a beaker at room temperature, deionized water according to the parts by mass was added, stirring (250-500 rpm). After a system is completely dissolved into a homogeneous solution, the inorganic nucleating agent according to the parts by mass was added, stirring at high speed (1200-1600 rpm) for 10 minutes to obtain the cryogenic inorganic phase change material.

### Example 2

This embodiment provides a cryogenic inorganic phase change material, calculated in 100 parts by mass, including the following parts by mass of raw materials:

38 parts of the main material (lithium bromide), 2 parts of the temperature regulating material (magnesium chloride), 1 part of the inorganic nucleating agent (0.5 part of sodium tetraborate and 0.5 part of nano-silica), and a remaining amount of deionized water.

The preparation method of the cryogenic inorganic phase change material refers to Example 1.

### Example 3

This embodiment provides a cryogenic inorganic phase change material, calculated in 100 parts by mass, including the following parts by mass of raw materials:

36 parts of the main material (lithium bromide), 4 parts of the temperature regulating material (2 parts of ammonium chloride and 2 parts of sodium bromide), 1 part of the inorganic nucleating agent (sodium tetraborate), and a remaining amount of deionized water.

The preparation method of the cryogenic inorganic phase change material refers to Example 1.

### Example 4

This embodiment provides a cryogenic inorganic phase change material, calculated in 100 parts by mass, including the following parts by mass of raw materials:

36 parts of the main material (lithium bromide), 4 parts of the temperature regulating material (magnesium chloride), 1 part of the inorganic nucleating agent (sodium tetraborate), and a remaining amount of deionized water.

The preparation method of the cryogenic inorganic phase change material refers to Example 1.

### Example 5

This embodiment provides a cryogenic inorganic phase change material, calculated in 100 parts by mass, including the following parts by mass of raw materials:

35 parts of the main material (lithium bromide), 4 parts of the temperature regulating material (2 parts of ammonium chloride and 2 parts of sodium bromide), 2 parts of the inorganic nucleating agent (1 part of sodium tetraborate and 1 part of nano-silica), and a remaining amount of deionized water.

The preparation method of the cryogenic inorganic phase change material refers to Example 1.

### Example 6

This embodiment provides a cryogenic inorganic phase change material, calculated in 100 parts by mass, including the following parts by mass of raw materials:

40 parts of the main material (lithium bromide), 2 parts of the temperature regulating material (1 part of ammonium chloride and 1 part of sodium bromide), 1 part of the inorganic nucleating agent (0.5 part of sodium tetraborate and 0.5 part of nano-silica), and a remaining amount of deionized water.

The preparation method of the cryogenic inorganic phase change material refers to Example 1.

### Comparative Example 1

This Comparative Example 1 provides an inorganic phase change material, calculated in 100 parts by mass, including the following parts by mass of raw materials:
40 parts of lithium bromide and a remaining amount of deionized water.
the preparation method of the inorganic phase change material refers to Example 1.

### Comparative Example 2

This Comparative Example 2 provides an inorganic phase change material, calculated in 100 parts by mass, including the following parts by mass of raw materials:
36 parts of the main material (lithium chloride), 4 parts of the temperature regulating material (magnesium chloride), 1 part of the inorganic nucleating agent (0.5 parts of sodium tetraborate and 0.5 parts of nano-silica), and a remaining amount of deionized water.

The preparation method of the inorganic phase change material refers to Example 1.

### Experiment Example 1

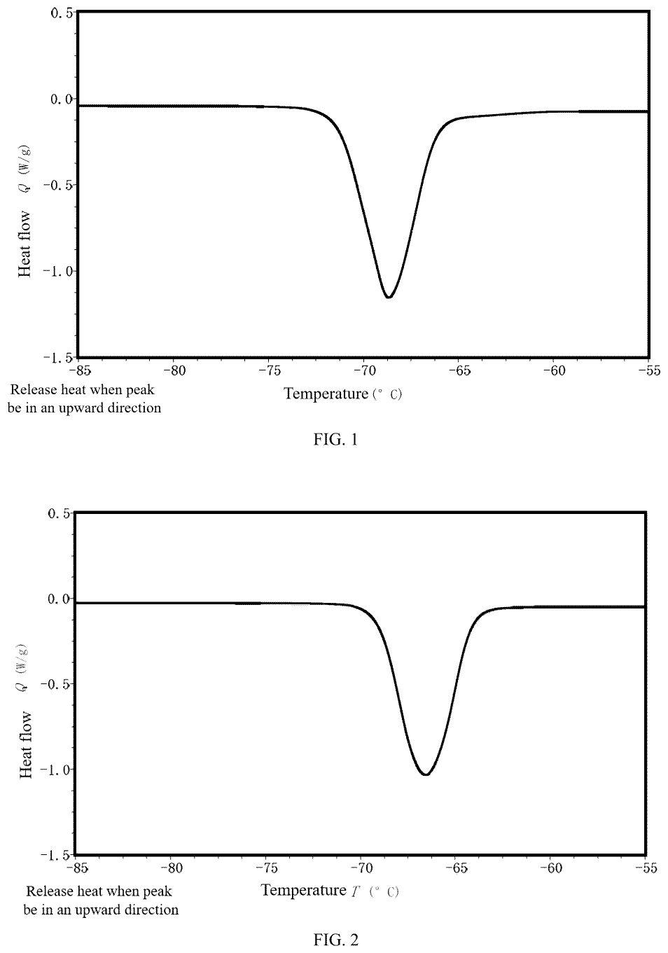

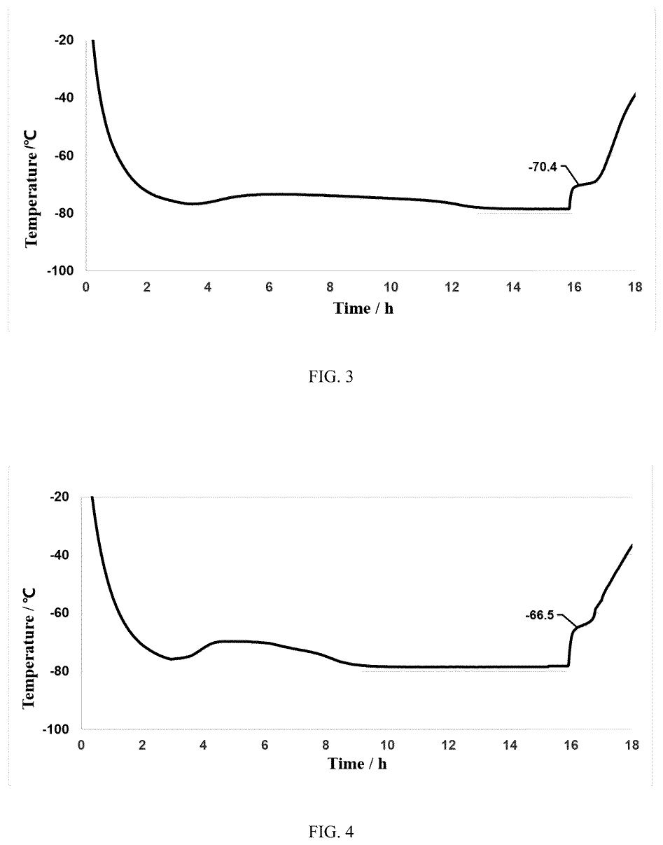

For the Examples and the inorganic phase change materials provided in Comparative Example, differential scanning calorimetry (DSC) was used for detection, and results are shown in Table 1. After the temperature regulating material was added, the phase change temperature of the cryogenic inorganic phase change materials was significantly reduced, and an enthalpy of phase change was slightly increased. For Comparative Example 1, the temperature control range was relatively high, close to −65° C., which indicates a significant risk of failure in an actual use. However, the temperature control range in Examples 1-6 effectively avoided the risk of high temperature. After conducting cooling and melting tests, the subcooling degree of Examples 1-6 were significantly reduced after the nucleating agent was added. As shown in FIGS. 1-4, which exemplary shown DSC curves and cooling/melting curves of Example 1 and Comparative Example 1.

TABLE 1

| | Range of phase | | |
|---|---|---|---|
| | transition | Enthalpy value | Subcooling |
| | temperature | of phase | degree |
| | (° C.) | change(J/g) | (° C.) |
| Example 1 | −72~−70 | 103.5 | 3.3 |
| Example 2 | −70~−68 | 100.5 | 4.9 |
| Example 3 | −72~−70 | 101.8 | 3.9 |
| Example 4 | −70~−68 | 97.2 | 5.3 |
| Example 5 | −72~−70 | 101.1 | 3.1 |
| Example 6 | −71~−68 | 102.4 | 3.5 |
| Comparative Example 1 | −68~−65 | 98.6 | 6.1 |

| | |
|---|---|
| Comparative Example 2 | The raw materials cannot be dissolved |

### Experiment Example 2

For Example 1, an insulated container composed of vacuum insulation plates was used for insulation testing. The environment temperature was tested according to the international standard ISTA 7D in summer high temperature. The specific conditions are shown in Table 2.

TABLE 2

| Temperature (° C.) | Time (h) |
|---|---|
| 22 | 4 |
| 35 | 2 |
| 30 | 12 |
| 35 | 6 |

The above four sections are one complete cycle, and 7 cycles are conducted.

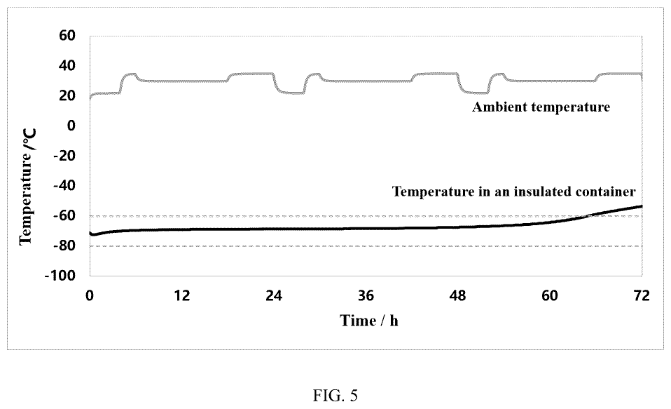

The results, as shown in FIG. 5, indicate that this phase change material has good temperature stability in the cryogenic temperature range.

Finally, it should be noted that the above embodiments are only used to illustrate the technical solution of the present disclosure, and not to limit it; although the present disclosure has been described in detail with reference to the embodiments, those skilled in the art should understand that they can still modify the technical solutions recorded in the embodiments, or equivalently replace some or all of the technical features thereof; and these modifications or replacements do not render the essence of the corresponding technical solutions deviate from the scope of the technical solutions of the various embodiments of the present disclosure.

What is claimed is:

1. A cryogenic inorganic phase change material, comprising parts by mass of raw materials in the following:
35-45 parts of a main material, 2-5 parts of a temperature regulating material, 0.5-2 parts of an inorganic nucleating agent, and 55-60 parts of a solvent;
wherein the main material is lithium bromide;
the temperature regulating material is one or more of ammonium chloride, magnesium chloride, calcium chloride, or sodium bromide.

2. The cryogenic inorganic phase change material according to claim 1, comprising parts by mass of raw materials in the following:
35-40 parts of the main material, 2-4 parts of the temperature regulating material, 1-2 parts of the inorganic nucleating agent, and 56-60 parts of the solvent.

3. The cryogenic inorganic phase change material according to claim 2, comprising parts by mass of raw materials in the following:
38 parts of the main material, 2 parts of the temperature regulating material, 1 part of the inorganic nucleating agent, and 59 parts of the solvent.

4. The cryogenic inorganic phase change material according to claim 2, comprising parts by mass of raw materials in the following:
36 parts of the main material, 4 parts of the temperature regulating material, 1 part of the inorganic nucleating agent, and 59 parts of the solvent.

5. The cryogenic inorganic phase change material according to claim 1, wherein the temperature regulating material is a mixture of ammonium chloride and sodium bromide.

6. The cryogenic inorganic phase change material according to claim 5, wherein a mass ratio of the ammonium chloride to sodium bromide is 1:1.

7. The cryogenic inorganic phase change material according to claim 1, wherein the inorganic nucleating agent is at least one of sodium tetraborate and nano-silica.

8. The cryogenic inorganic phase change material according to claim 7, wherein the inorganic nucleating agent is a mixture of the sodium tetraborate and the nano-silica, and a mass ratio of the sodium tetraborate to the nano-silica is 1:1.

9. The cryogenic inorganic phase change material according to claim 1, wherein the solvent is deionized water.

10. A preparation method for the cryogenic inorganic phase change material according to claim 1, comprising the following steps:
S1: weighing the main material, temperature regulating material, inorganic nucleating agent, and solvent according to a formula amount;
S2: stirring and mixing the main material, temperature regulating material, and solvent evenly;
S3: adding the inorganic nucleating agent, continuing to stirring and dispersing evenly to obtain the cryogenic inorganic phase change material.

11. An application of the cryogenic inorganic phase change material according to claim 1, wherein the cryogenic inorganic phase change material is configured to be applied in an ultra-low temperature control scenario, and an ultra-low temperature control range is −72 to −70° C.
